(19) United States
(12) Patent Application Publication
(10) Pub. No.: US 2014/0308410 A1
(43) Pub. Date: Oct. 16, 2014

(54) Package Including A Tray Which Contains a Group of Flanged Containers

(71) Applicant: COMPAGNIE GERVAIS DANONE, Paris (FR)

(72) Inventor: Patrick Marechal, Antony (FR)

(21) Appl. No.: 14/358,880

(22) PCT Filed: Nov. 17, 2011
(86) PCT No.: PCT/IB2011/003031

§ 371 Date: May 16, 2014

(51) Int. Cl. B65D 71/54; A23C 9/123

(52) U.S. Cl. CPC B65D 71/0007; A23C 9/123
USPC 426/130; 426/106

(57) ABSTRACT

The package (1) comprises a cardboard tray (T) with a bottom panel and side panels (31, 32, 33, 34) and a plurality of flanged containers (2) arranged in the tray in a plurality of rows (4a-4f). Each of the containers comprises a body (2a), an opening defined by the body upper face, and an annular flange (5) extending in a plane outwardly from the opening completely around the periphery of the opening. At least in an external row (4a), at the row ends, the flanges (5a) comprise a corner portion (5a) having one of a rounded shape and an oblique shape. The panels of the tray (T) may extend from the bottom panel and include two first side panels (31, 32), two second side panels (33, 34) that extend perpendicularly to the first side panels, and oblique corner panels (35, 36, 37, 38).

### FIELD OF THE INVENTION

The present invention generally relates to the package of flanged containers used in food package industry, particularly for thermoformed plastic flanged containers, such as yoghurt pots or similar.

More particularly, the invention relates to a package, in particular a yoghurt package, comprising:
a cardboard open top tray that comprises a bottom panel and side panels to define an internal volume;
a group of flanged containers arranged in said internal volume in a plurality of rows each composed of at least two adjacent containers, said plurality of rows comprising a first row located at one front end of the package, the containers being distributed on the upper surface of the bottom panel, each of the containers comprising:
   a body extending along a longitudinal axis from a base in contact with said bottom of the tray as far as an upper face;
   an opening provided on the upper face of the body; and
   an annular flange surrounding the opening, said flange comprising an upper face, a lower face and four sides, the flange extending in a plane outwardly from said opening completely around the periphery of the opening, at least two of the four sides of the flange defining each rectilinear edges, each of said rectilinear edges facing one of the side panels.

### BACKGROUND OF THE INVENTION

This package is commonly encountered in the food industry, in particular for transporting yoghurt pots or similar flanged containers from the site of production to a supermarket. The containers may be plastic pots conventionally sealed with membranes and can be manufactured and sold in a multiple portion package tray comprising an array of separable containers. It is understood that the flange is sized to prevent any contact between the body of the flanged containers and the side panels of the tray. The containers are generally arranged in packs of four, six or eight containers and connected to one another along their flanges. The tray is typically a stackable low depth case adapted to contain a layer of flanged containers or a stackable case adapted to contain two layers of flanged containers as shown in the document FR 2 862 615.

The trays filled with the flanged containers are stacked on pallets (in Europe for instance, size of a pallet is typically 80×120 cm). The trays are stacked in columns due to the fact that trays are open top trays that cannot be cross stacked. A wrap (a stretch film or a band) can be used in order to maintain cohesion of the columns on the pallet. For yoghurt pots, a further constraint is to enable air flowing through the pallet for cooling.

The stacks have to show a good stability in the vertical direction and package at the lower level in the stack should have a sufficient strength for supporting the compression load of the trays placed above in the stack. A loading weight on a pallet may be much more than 500 kg. The side panels of the tray prevent lateral tilting of the layers. Furthermore, there is a need for limiting the package material to the “just necessary”.

The weight of the container material may be decreased by lowering density of the material. For plastic flanged containers as a way of example, air bubbles may be introduced in the plastic material (for instance polystyrene). A weight reduction in the dairy product field would thus be highly desirable but the weight of the primary package (i.e. the flanged containers) can be reduced only if the aspect of the containers remains attractive for the consumers. In particular, the containers appearance (outstanding shelf presence) and the integrity of the content of the containers as well (especially for the containers placed at the lower level of a stack) should not be impacted by a weight reduction of the container material.

There are already some solutions to provide to the consumers flanged containers with less material. However, the weight of the plastic containers cannot be easily reduced since the containers made of relatively brittle plastic have to be transported in a safe manner and without any deformation. It is also preferably required that the containers are user-friendly, i.e. not complicating user's operations such as separating an individual container, opening the seal membrane, eating the content.

### SUMMARY OF THE INVENTION

The purpose of the present invention is to provide a robust package for transportation of a dairy product or similar in individual flanged containers addressing one or more of the above mentioned problems.

To this end, embodiments of the present invention provide a package of the above mentioned type, characterized in that the side panels of the tray comprise:
two first side panels that extend from the bottom panel,
two second side panels that extend from the bottom panel perpendicularly to said first side panels, and
oblique corner panels each extending between one of the first side panels and one of the second side panels, at least at said front end of the package;
   and wherein at least in said first row, the flanges are each provided with a corner portion having at least one of a rounded shape and an oblique shape, said oblique corner panels at said front end being each arranged to directly face one of said corner portions and preferably adapted to contact one of the flanges in said first row at said corner portion.

Advantageously, the oblique angles provide a rigidifying effect and allow a better strength of the package in the corners (at least at the front end of the package), whereby the weight of the containers may be reduced without affecting the aspect of some of the containers after transportation on a pallet. The arrangement of the containers in the tray remains compact as the clearance between the containers (at least in the first row) and adjacent side walls of the tray is reduced to a small amount. Such effects thus allow the total weight of the package to be reduced without decreasing stacking capacity of the package.

In various embodiments of the package according to the invention, one or more of the following arrangements may optionally be used:
the four sides of the flange of the containers each define rectilinear edges (with such an arrangement, the contact area between the flange and the side panels may be increased and a better alignment of the containers inside the tray to form rows is obtained).
the corner portion defines a curved edge contiguous to two of said rectilinear edges that are each maintained at a distance from the adjacent oblique corner panel by a contact between said curved edge and said oblique corner panel (with such a configuration, the size of the flange is reduced as compared to the size of a flange having a more squared outer shape, thus minimizing the weight of the container).
at least in said first row, each flange of the containers comprises a first flange portion that extends substantially parallel to the two first side panels and a second flange portion that extends substantially parallel to the two second side panels, the corner portion being contiguous to the first flange portion and to the second flange portion.
at least in said first row, said flange of the containers is integrally formed with the body and has a thickness inferior to 1 mm.
the flanges of all the containers are each provided with at least two corner portions of rounded shape and contiguous to a same side of said four sides.
for each of the flanged containers, a membrane seal is fixed only to the upper face of the flange, the membrane seal sealing the opening and covering entirely the upper face of the flange.

According to another feature, the tray, which is preferably formed from a blank, comprises four side panels extending from a bottom as far as an upper edge and wherein the bottom panel has at least six generally rectilinear sides, the bottom of each of said four side panels being generally coextensive with one of said bottom panel rectilinear sides, said oblique corner panels being each defined at a junction between one of the first side panels and one of the second side panels and forming corner sides of the tray.

According to a particular feature, the bottom panel has eight generally rectilinear sides, four of the oblique corner panels extending from four respective sides of the bottom panel. The tray is thus octagonal and may comprise two long sides and two short sides.

According to a particular feature, each of the flanges defines an external perimeter and said flange corner portion defines a rounded rim portion having an external perimeter portion, the length of the external perimeter portion corresponding to at least 1/10 of the length of the external perimeter. Preferably, the flange comprises at least two corner portions defining such a rounded rim. The opening may also be circular and the body of the containers may have a circular cross-section. With such an arrangement, the flange size may be reduced and the weight of the plastic material minimized.

According to a particular feature, the body and the flange of the containers are made from a same plastic material, preferably polystyrene, the cardboard tray having a weight comprised between ⅛ and ¼, preferably between 1/7 and ⅕, of the weight of the plastic material of the flanged containers. With such an arrangement, the package material may be chosen with a low density (for instance not superior to 0.8-1 g/cm³ for the plastic material, while the cardboard weight may be not superior to 350-500 g/m²) and the tray provided with the corner panels will efficiently protect the plastic containers when the package is stacked and transported.

It is also provided, according to the invention, a use of a package according to the invention, wherein the flanged containers each contain a dairy product, preferably a yoghurt composition having a weight not inferior to 75 g and not superior to 200 g.

A further purpose of the invention is to provide a stack arrangement of trays filled with flanged containers such as yoghurt pots.

To this end, embodiments of the present invention provide an arrangement of a plurality of packages according to the invention, wherein the trays are stacked according to a main direction perpendicular to the bottom panel of each tray, so as to form at least one track each containing at least 120 flanged containers, and preferably at least 200 flanged containers, the number of flanged containers per tray being preferably not superior to 32.

Other features and advantages of the invention will become apparent to those skilled in the art during the description which will follow, given by way of a non-limiting example, with reference to the appended drawings.

### BRIEF DESCRIPTION OF THE DRAWINGS

FIG. 1 is a perspective view of a package in accordance with a first embodiment of the invention;

FIG. 2 is a perspective view showing a stacked configuration, which is obtained using cardboard trays as shown in the package of FIG. 1;

FIG. 3 is a plan view of a blank of sheet material from which the tray as illustrated in FIGS. 1-2 may be formed;

FIGS. 4 and 5 are two respective close-up views of the embodiment shown in FIG. 1;

FIG. 6 is a schematic view showing a stackable cardboard tray and arrays of containers to be boxed in the tray, in accordance to a second embodiment of the invention;

FIG. 7 shows a fragmentary perspective view of a portion of an alternative cardboard tray in an erected state, such a tray being adapted to form a package in accordance with a third embodiment of the invention;

FIG. 8 illustrates a detail of a package in accordance with a fourth embodiment of the invention.

### DETAILED DESCRIPTION OF EMBODIMENTS

In the various figures, the same references are used to designate identical or similar elements.

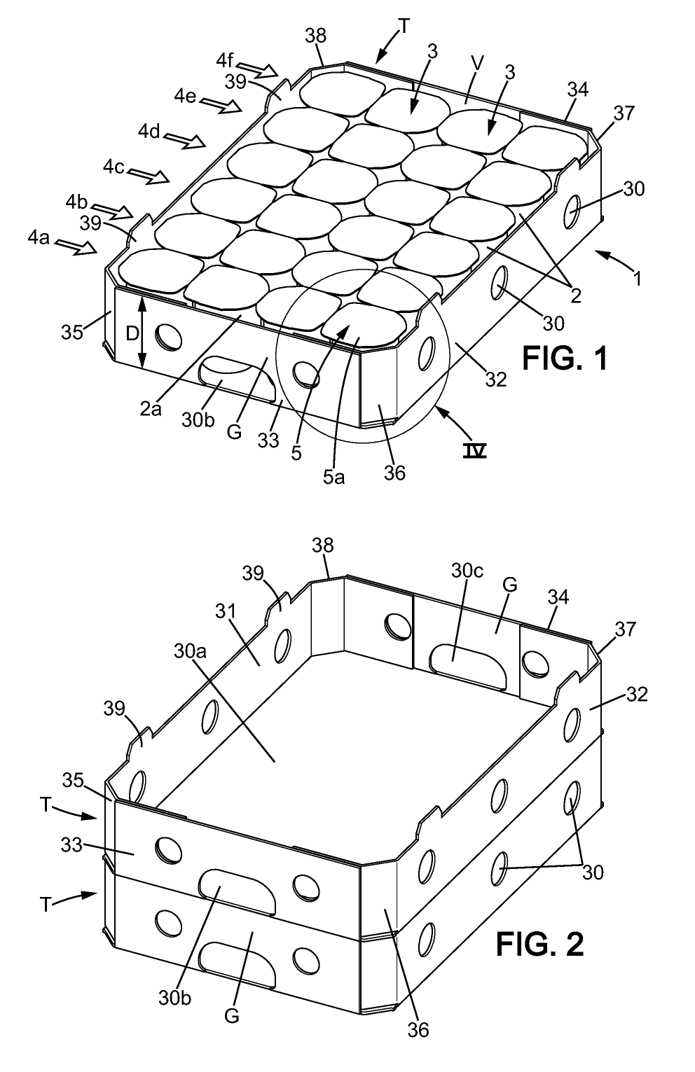

FIG. 1 shows a stackable package 1 which comprises a stackable low depth tray T, here containing a single layer of containers 2 according to a non limitative first embodiment. The containers 2 may be yoghurt cups or similar dairy product containers and may be grouped to form respective dairy product packs 3. Each pack 3 comprises for instance four individual containers 2. Of course the number of containers 2 may vary and a number of 2, 6, 8, 10 or 12 containers 2 may be provided, in a non-limitative example.

The containers 2 are arranged in at least one row 4a, 4bn 4c, 4d, 4e, 4f inside the internal volume V of the tray T, and preferably at least in two rows. Each of the packs 3 may typically be part of two adjacent rows 4a, 4b or 4c, 4d, 4e, 4f but many other configurations are available. Furthermore, it should be understood that, the depth D of the tray T may be adapted so that two layers of containers 2 may be boxed in the internal volume V.

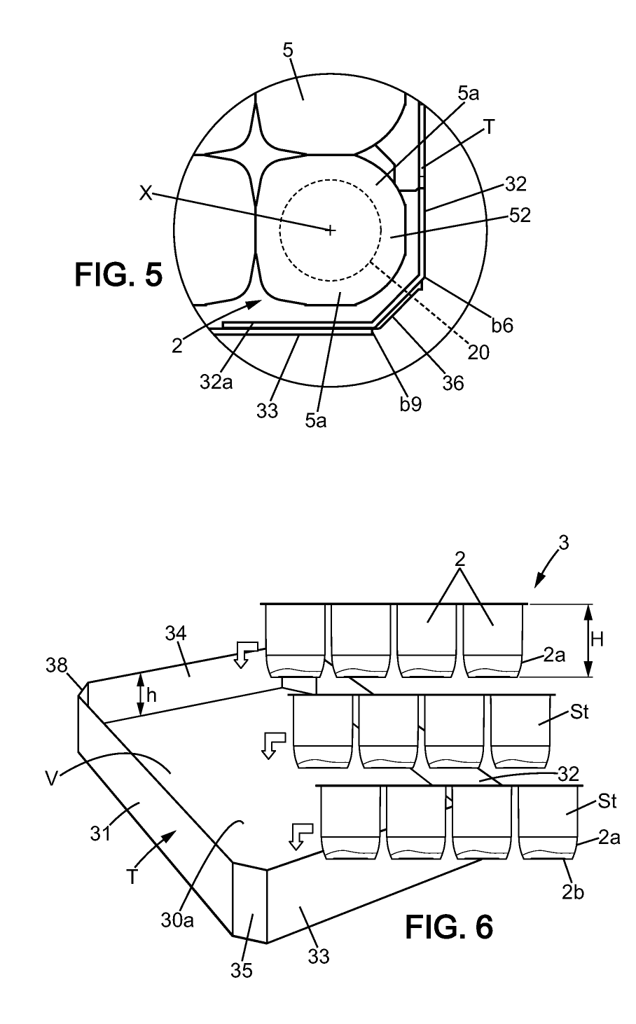

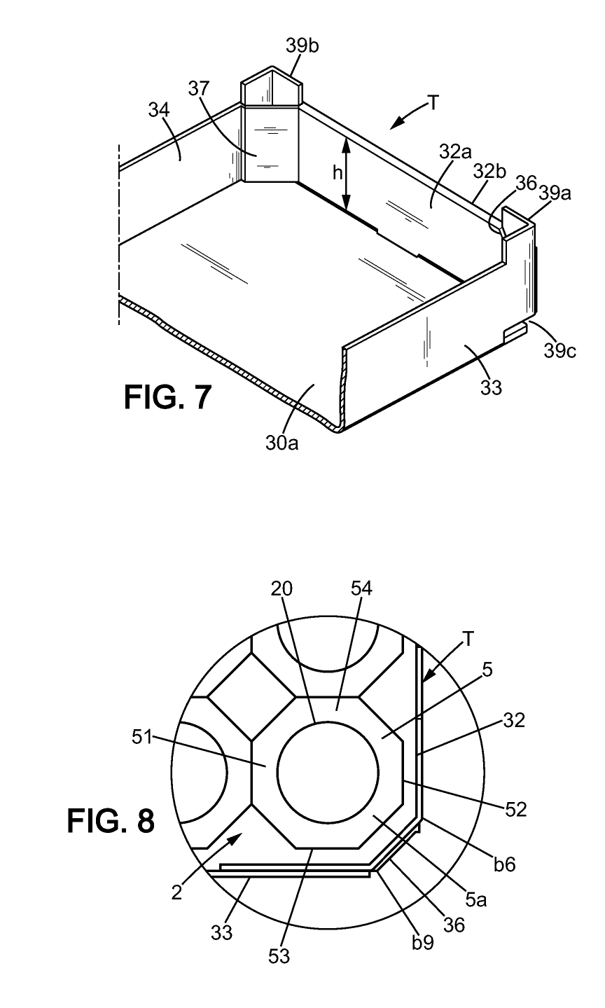

The tray T will be more particularly described in connection with FIGS. 1-3 (first embodiment) and FIGS. 6-7 (second and third embodiments, respectively)

As shown in FIG. 3, the tray T is a case obtained from a cardboard blank B provided with a central bottom panel 30a. Pairs of sides of s1, s2; s3, s4 of the bottom panel 30a are parallel to each other. The tray T here defines an almost parallelepiped internal volume V to house the containers 2. The cardboard material is highly preferred for a plurality of reasons: cost, low density, shaping, cut adaptability . . . Optional holes 30 are obtained from a cut on the side panels 31, 32, 33, 34 of the blank B, to enable air flowing along the body 2a of the containers 2. This is required in particular for an efficient cooling of the dairy product such as yoghurt or similar fresh products. Of course, such holes 30 may be combined with or replaced by suitable openings arranged for instance between different panels of the tray T. Additional holes O may also be provided on the bottom panel 30a as shown in FIG. 3. Two opposite apertures 30b, 30c, here adjacent to the bottom panel 30a in this non limitative example, may also be provided to form handles G.

As shown in the FIGS. 1-3, the tray T has at least six sides, and preferably height sides, and here comprises:
the bottom panel 30a, which has an upper surface, a lower surface and at least six generally rectilinear sides s1-s6, preferably height rectilinear sides s1-s8 as shown in FIG. 3,
two first side panels 31, 32 that extend from the bottom panel 30a,
two second side panels 33, 34 that extend from the bottom panel 30a perpendicularly to the two first side panels 31, 32, and
oblique corner panels 35, 36, 37, 38 each extending between one of the first side panels 31, 32 and one of the second side panels 33, 34.

The handles G are here provided at a rear end and at a front end of the package 1, on the short side panels 33, 34, but could also be provided (alternatively or in addition) on the long first side panels 31, 32. The panels 31, 32, 33, 34 extend each from a bottom as far as an upper edge. Tabs 39 may be provided at some of the upper edges, in order to facilitate staking of several packages 1. The trays T may be stacked according to a main direction perpendicular to the bottom panel 30a, so as to form at least one track.

At least at the front end of the package 1, two oblique corner panels 35, 36 are provided. Referring to FIGS. 1-2, these two oblique corner panels 35, 36 are here adjacent to the front side panel 33. Preferably, two other oblique corner panels 37, 38 are provided at the rear end of the package 1, adjacent to the rear side panel 34.

Referring to FIG. 3, pairs of sides of s5, s7; and s6, s8; are optionally parallel to each other.

Sides s3 and s4 of the bottom panel 30a are separated by scorelines from the side panel 33 and the side panel 36. Separated by scorelines from sides s1 and s2 are long side panels 31 and 32 opposite thereto. Long side panel scorelines b5, b8 separate the long side panel 31 from oblique panels 35 and 38 on either side of this long side panel 31. Similarly, long side panel scorelines b6, b7 separate the long side panel 32 from oblique corner panels 36 and 37 on either side of this long side panel 32.

Still referring to FIG. 3, extending from oblique corner panels 35 and 38 (respectively) on sides opposite the long side panel 31 are attachment panels 31a and 31b. Similarly, from oblique corner panels 36 and 37 on sides opposite the long side panel 32 are attachment panels 32a and 32b.

Referring to FIGS. 1-2 and 4-5, the oblique corner panels 35, 36, 37, 38, are each defined at a junction between one of the first side panels 31, 32 and one of the second side panels 33, 34. “Oblique” refers to the fact that these extend diagonally to panels on either side when the blank B is erected (i.e. diagonally with respect to the general parallelepiped shape defined by the first and second side panels 31, 32, 33, 34).

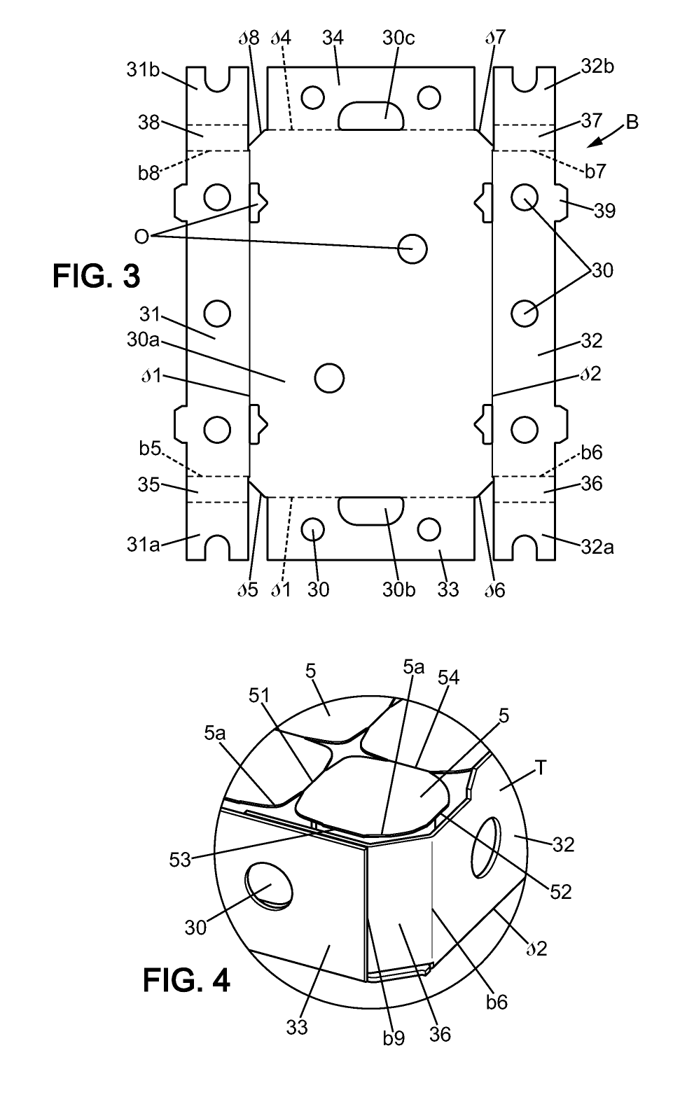

The detail of FIG. 4 shows one corner side of the tray (T) obtained after erecting the blank B shown in FIG. 3. The oblique panel 36 extends between two parallel scorelines b6, b9. This arrangement of the tray T offers a better strength in the corners.

The cardboard blank B may be formed using a conventional cutting method. Portions are removed to make the bottom panel 30a height sided and to make the first and second side panels 31, 32, 33, 34 generally coextensive with one of said bottom panel rectilinear sides s1, s2, s3, s4.

Although the embodiment of FIGS. 1-5 shows attachment panels 31a, 31b, 32a, 32b and oblique corner panels 35, 36, 37, 38 arranged at respective ends of the first side panels 31, 32, it should be understood that the oblique corner panels may be obtained in a different way and may for instance be directly connected to the bottom panel 30a or to the respective second side panels 33, 34. Furthermore, the bottom panel 30a of the tray T may also be shaped with sides s1, s2, s3, s4 having a same length. Those skilled in the art will also understand that handles G should be considered as optional. More generally, any suitable shape may be used to obtain the tray T.

Referring to FIG. 6, the shape of the tray T with an octagonal bottom panel 30a may be obtained with a different way for connecting the adjacent side panels 31, 32, 33, 34. In this second embodiment, three packs 3 of 4N containers 2 (with N≧1) are for instance arranged inside the interior volume V defined by the tray T. The containers 2 are distributed on the whole upper surface of the bottom panel 30a. The side panels 31, 32, 33, 34 of the tray T may have a height h equal or slightly superior to the height H of the containers 2 but could also be equal or slightly superior to twice this height H. The side panels 31, 32, 33, 34 are in contact with some of the flange sides of the pack 1.

Now referring to FIG. 7, the bottom panel 30a may be rectangular. The tray like structure includes corner posts with portions 39a, 39b projecting upwardly upon the upper edges of the side walls. The corners are provided with openings 39c at the bottom thereof for receiving projections of related tray T to provide interlocking engagement when the packages 1 are stacked with each other.

In this third embodiment, while two opposed side walls include respective panels 33, 34, the two other side walls include each an outer panel and an inner panel (only the outer panel 32b and the inner panel 32a are shown in FIG. 7). The inner panel 32a may be foldably joined at its upper edge to the upper edge of related outer panel 32b by at least one fold line. With a pair of fold lines, a relatively narrow upper hinge strip maybe defined therebetween which connects the inner and outer panels to each other.

As shown in FIG. 7, because of the side portions forming the oblique panels 36, 37, the inner panel 32a has here a length which is greater then the length of the outer panel 32b. Of course, the height h of the side panels 32a, 32b, 33 and 34 may be the same as in the first and second embodiments. It can be seen that the oblique panels 36, 37 are disposed to extend diagonally across the corners of the tray T from the side edges of the inner panel center portion (this center portion having the same length as the outer portion 32b) to the inside surfaces of adjacent portions of related side panels 33, 34 in order to form reinforcing integral corner post structures. This tray T, which has a one piece structure, thus permits an increased protection for the flanged containers 2.

The package 1 including the flanged containers 2 will be now described in connection with FIGS. 1 and 4-7.

The containers 2 of the package 1 are here intended to contain a dairy product, for instance a yoghurt composition or the like. For each of the containers 2, the yoghurt composition may have a weight not inferior to 75 g and not superior to 200 g. Referring to FIGS. 5-6, the containers 2 have each a hollow body 2a shaped and sized to be easy taken by one hand, the body 2a extending along a longitudinal axis X from a base 2b as far as an upper face provided with an opening 20. Such an opening 20 is relatively wide and typically larger than the base 2b. This facilitates retrieving of the dairy product using a spoon. It is understood that the longitudinal axis (not shown) of the body 2a is here a central axis for the body 2a and the opening 20.

The body 2a and the flange 5 of the containers 2 are made from a same plastic material, preferably polystyrene or a suitable polyolefin (polyethylene, polypropylene for instance). Here, the flange 5 is integrally formed with the body 2a. Regarding the package 1 shown in FIG. 1, the weight of the cardboard material used for the tray T is much inferior to the weight of plastic material used for the containers 2. In one non limitative example, the weight of the cardboard material is comprised between ⅛ and ¼ of the weight of the plastic material.

Using the tray structure with reinforcements in the corners as described above, the weight of plastic material in the containers 2 can be significantly reduced without impairing integrity of the product contained in the package 1. To decrease the amount of plastic material, a hollow body 2a having a circular cross-section and a circular opening may be preferred. Preferably, the polystyrene or the like used in the container 2 has a thickness e of about 0.2 mm in the body 5 and a thickness E of about 0.85 mm in the flange 10. The thickness may vary depending upon the food package application and may be inferior to 1 mm and superior to 0.7 mm (the range 0.8-0.9 mm being preferred). Thicker materials may be used for heavier food products.

Referring to FIGS. 4-6, a film called thereafter a membrane seal S is used to cover the containers 2. Such a membrane seal S may be a plastic film made from plastic resin or a foil film. An adhesive may be used to seal the film to the upper face of the flange 5. The membrane seal S entirely covers this upper face.

Referring to FIG. 6, the side wall of the body 2a is tubular and is here adapted to be covered by a cylindrical decorative strip St, sticker or banderol. Such a strip increases the appearance of the packs 1 of containers and identification of the content is facilitated.

Referring to FIG. 1, each of the containers 2 comprises an annular flange 5 surrounding the opening 20 which is here defined by the upper face of the body 2a. Each flange 5 extends outwardly from the opening 20 completely around the periphery of the opening 20. This opening 20 may be circular as shown in FIGS. 5 and 8 but any other shape, for instance oval or substantially squared, may be used. The flange 5 comprises an upper face, a lower face and preferably four sides. While the body 2a is in contact with the bottom panel 30a of the tray, the flange 5 here prevents any other contact of the body 2a with the tray T.

In the package 1, the flanges 5 all extend in a same plane and may form the packs 3. In a preferred embodiment, the containers 2 of a same pack 3 (with a number of 2, 4, 6 or 8 containers 2 for instance) are fastened to each other at the flanges 5. Rectilinear edges of the flanges 5 are connected together with a break-away connection. Preferably the weakened lines that define the break-away connection are precut lines.

In the internal volume V of the tray T, the rows 4a, 4b, 4c, 4d, 4e, 4f defined by the group of containers 2 comprise each at least two, and preferably at least four adjacent containers 2. Preferably, the number of containers 2 is the same for each of the rows 4a, 4b, 4c, 4d, 4e, 4f. In a preferred embodiment, adjacent parts of the rows 4a and 4b are fastened to each other. More generally, it will be understood that the tray 1 may contain packs 3 extending in at least two successive rows. In the non limitative example of FIGS. 1 and 4-5, the first row 4a is here located at one front end of the package 1, i.e. adjacent the side panel 33. At least in this first row 4a, the flanges 5 are each provided with a corner portion 5a having a rounded shape located in the corner area of the tray T. Accordingly, the corner panels 35, 36 at this front end are each directly facing the related corner portion 5a. With this arrangement, the flanges of the containers 2 located in the first row 4a may be substantially aligned and in contact with the front end wall defined by the side panel 33 and the adjacent oblique corner panels 35, 36. Should a contact occur between the containers 2 and the oblique panel 35, 36, only the corner portion 5 will be in contact with the related oblique corner panel 35 or 36.

Referring to FIGS. 4 and 5, the four flange portions 51, 52, 53, 54 or sides of the flange 5 of the containers 2 each define rectilinear edges. At each of the two ends of the first row 4a, the corner portion 5a may define a curved edge contiguous to two of the rectilinear edges. In each flange 5 of the containers, one and preferably two first flange portions 51, 55 that extend substantially parallel to the two first side panels 31, 32 are provided. Similarly, one and preferably two second flange portions 53, 54 that extend substantially parallel to the two second side panels 33, 34 are provided. The corner portion 5a here separates the first flange portion 52 with a first rectilinear edge facing the side panel 32 from the second flange portion 53 with a second rectilinear edge facing the side panel 33. These first and second rectilinear edges are each maintained at a distance from the related oblique panel 35 or 36 by the contact between the curved edge of the corner portion 5a and the oblique corner panel 35 or 36.

As shown in FIG. 5, each of the flanges 5 defines an external perimeter defined by the sum of the contiguous perimeter portions. Here, the flange corner portion 5a has an external perimeter portion, the length of which corresponds to at least 1/10 of the length of the whole external perimeter. Accordingly, the flange corner portion may be arcuated with a relatively large radius of curvature. This arrangement of the flanges 5 at least in the corner areas of the package 1 permits to increase the spacing between the two parallel scorelines b6, b9 shown in FIGS. 4-5, without reducing the number of containers 2 or increasing dimensions of the tray T as compared with the use of a conventional tray T having a rectangular bottom panel. In a stack of several packages, the number of the containers 2m may be at least equal to 120, and preferably not inferior to 200. The number of flanged containers per tray is not superior to 32. Referring to the example, of FIG. 1, the number of containers 2 in one tray T may be 24, the containers 2 being distributed on the whole surface (upper surface) of the bottom panel 30a.

As shown in FIG. 1, the same arrangement may be used in the last row 4f with respect to the oblique corners 37 and 38. Referring to FIG. 5, the two corner portions 5a are contiguous to the flange portion 52. More generally, the flanges 5 of all the containers 2 may be each provided with at least two corner portions 5a of rounded shape and contiguous to a same side of the four sides.

Still referring to FIG. 5, the flange 5 may extend around a longitudinal axis X with such a geometrical shape that this longitudinal axis X forms an intersection between:
a first median plane dividing the flange 5 into two symmetrical halves; and
a second median plane perpendicular to the first median plane and dividing the flange 5 into a first C-shaped portion and a second C-shaped portion.

With such a flange 5 provided with the circular opening 20, a good compromise is obtained between savings of material, size of the opening diameter for an easy access to the content, facility to remove the membrane seal S, and boxing of the packs 1 in the corner areas of the tray T.

Now referring to FIG. 8, a fourth embodiment is shown with containers 2 of the first row 4a having their flanges 5 provided with an octagonal shape. As in the FIGS. 4-5, the four flange portions 51, 52, 53, 54 or sides of the flange 5 of the containers 2 define respective rectilinear edges. However, the corner portion 5a is arranged diagonally and thus has an oblique shape.

Such a shape matches with the corner structure of the tray T as described in the precedent figures and alignment of the containers 2 of the first row 4a is obtained. The flange 5 may also be provided with a circular opening 20. Of course, the octagonal shape of the flange 5 may be slightly modified to obtain minute curved portions at each junction between two adjacent rectilinear edges.

Of course, the containers 2 of the present invention are not in any way limited to yoghurt but can be intended to contain all sorts of liquid, semi-liquid or flowable edible products. A container 2 adapted to receive 125 g of a yoghurt composition or similar may be provided with a flange 5 having a diameter of the circular opening 20 equal to about 53-54 mm, while the length of the flange 5 (i.e. the distance between two parallel outer straight side edges) is equal to about 63 mm and the height H of the container 2 may be equal to about 66-67 mm.

The present invention has been described in connection with the preferred embodiments. These embodiments, however, are merely for example and the invention is not restricted thereto. It will be understood by those skilled in the art that other variations and modifications can easily be made within the scope of the invention as defined by the appended claims, thus it is only intended that the present invention be limited by the following claims.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A package for transportation of dairy product, comprising:
a cardboard open top tray that comprises a bottom panel and side panels to define an internal volume, the bottom panel having a lower surface and an upper surface;
a group of flanged containers arranged in said internal volume in a plurality of rows each composed of at least two adjacent containers, said plurality of rows comprising a first row located at one front end of the package, the containers being distributed on the upper surface of the bottom panel, each of the containers comprising:
a body, which has a base in contact with said bottom of the tray, and which extends along a longitudinal axis from the base as far as an upper face;
an opening provided on the upper face of the body; and
an annular flange surrounding the opening, said flange comprising an upper face, a lower face and four sides, the flange extending in a plane outwardly from said opening completely around the periphery of the opening, at least two of the four sides of the flange defining each rectilinear edges, each of said rectilinear edges facing one of the side panels;
wherein said side panels of the tray comprise:
two first side panels that extend from the bottom panel,
two second side panels that extend from the bottom panel perpendicularly to said first side panels, and
oblique corner panels at least at said front end of the package, each extending between one of the first side panels and one of the second side panels;
and wherein at least in said first row, the flanges are each provided with a corner portion having at least one of a rounded shape and an oblique shape, each of said oblique corner panels at said front end being directly facing one of said corner portions,
each of the flanges defining an external perimeter, said flange corner portion defines a rounded rim portion having an external perimeter portion when said corner portion has a rounded shape, the length of the external perimeter portion corresponding to at least 0.1 of the length of said external perimeter.

2. The package according to claim 1, wherein each of said oblique corner panels at said front end is in contact with one of the flanges in said first row at said corner portion.

3. The package according to claim 1, wherein said four sides of the flange of the containers define each rectilinear edges.

4. The package according to claim 3, wherein said corner portion defines a curved edge contiguous to two of said rectilinear edges that are each maintained at a distance from the adjacent oblique corner panel by a contact between said curved edge and said oblique corner panel.

5. The package according to claim 3 4, wherein at least in said first row, each flange of the containers comprises a first flange portion that extends substantially parallel to the two first side panels and a second flange portion that extends substantially parallel to the two second side panels, said corner portion being contiguous to said first flange portion and to said second flange portion.

6. The package according to claim 1, wherein at least in said first row, said flange of the containers is integrally formed with the body and has a thickness inferior to 1 mm.

7. The package according to claim 3, wherein the flanges of all the containers are each provided with at least two corner portions of rounded shape and contiguous to a same side of said four sides.

8. The package according to claim 1, wherein for each of the flanged containers, a membrane seal is fixed only to the upper face of the flange, the membrane seal sealing the opening and covering entirely said upper face of the flange.

9. The package according to claim 14, wherein the tray, which is formed from a blank, comprises four side panels extending from a bottom as far as an upper edge and wherein the bottom panel has at least six generally rectilinear sides, each of said four side panels being generally coextensive with one of said bottom panel rectilinear sides, said oblique corner panels being each defined at a junction between one of the first side panels and one of the second side panels and forming corner sides of the tray.

10. The package according to claim 14, wherein the bottom panel has eight generally rectilinear sides, four of the oblique corner panels extending from four respective sides of the bottom panel.

11. The package according to claim 1, wherein the body and the flange of the containers are made from a same plastic material, the cardboard tray having a weight comprised between ⅛ and ¼ of the weight of said plastic material of the flanged containers.

12. The package according to claim 1, wherein each of the flanged containers contains a yoghurt composition having a weight not inferior to 75 g and not superior to 200 g.

13. (canceled)

14. The package according to claim 3, wherein the first row extends along a determined direction perpendicularly to each of the first side panels and has a length measured according to the determined direction, at least one of the second side panels having a length, measured according to said determined direction, which is inferior to the length of said first row.

15. The package according to claim 1, wherein said corner portion has a rounded shape and the ratio between the length of the external perimeter portion and the length of said external perimeter is from 0.1:1 to 0.2:1.
